(19) United States
(12) Patent Application Publication
(10) Pub. No.: US 2010/0088211 A1
(43) Pub. Date: Apr. 8, 2010

(54) DEBT SECURITY HAVING RETURN INVERSELY RELATED TO ASSOCIATED SECURITY

(76) Inventor: Jeffrey Yass, Haverford, PA (US)

Correspondence Address: FISH & RICHARDSON P.C., P.O. BOX 1022, MINNEAPOLIS, MN, 55440-1022, US

(21) Appl. No.: 12/244,190

(22) Filed: Oct. 2, 2008

(51) Int. Cl. G06Q 40/00

(52) U.S. Cl. 705/37

(57) ABSTRACT

According to some implementations, a method comprises creating a debt security, wherein the debt security has a creation date and a maturity date, further wherein the debt security is associated with at least one security; issuing the debt security with a principal amount; and determining a rate of return for the debt security at the maturity date, wherein the rate of return for the debt security is inversely related to a rate of return of the associated at least one security between the creation date and the maturity date. According to some implementations, an exchange traded note comprises at least one associated security; and a rate of return, wherein the rate of return for the exchange traded note is inversely related to a rate of return of the associated at least one security between a creation date and a maturity date.

### FIELD

The present disclosure relates to the field of debt securities, and in particular, to an Exchange Traded Note whose return is inversely related to the performance of an associated security.

### BACKGROUND

Short-selling a stock or other security is an investment tool that allows an investor to profit from a decrease in value of the security. Short sellers typically borrow a security and sell it at one price, expecting that it will decrease in value so that they can buy it back at a lower price and keep the difference when they return the original security to the lender.

While short selling is a useful investing tool, there are currently some disadvantages associated with short selling a security. In particular, Regulation SHO generally requires a securities broker-dealer to have reasonable grounds to believe that a security can be borrowed so that it can be delivered on the date delivery is due before effecting a short sale order of that security. For example, a particular stock or security may be infrequently traded or may not have many publicly available shares; this may cause the broker-dealer to not have reasonable grounds to believe that the security can be borrowed so that it can be delivered on the date delivery is due. Similarly, a list of stocks or securities appearing on the “Hard-to-Borrow” list identifies those stocks or securities considered difficult or unavailable to borrow for short-selling. These scenarios may result in an investor being unable to short-sell certain stocks or securities.

An Exchange Traded Note (“ETN”) is an example of a debt security. Typically, ETNs are issued by an investment bank. As with other unsecured debt securities, ETNs are generally backed only by the credit of the issuer and have an associated maturity date (i.e., when the principal and cumulative return of an ETN are paid to a holder). In some cases, ETNs may also be redeemed prior to the maturity date by paying an early redemption fee to the issuer, for example.

ETNs are typically used to provide investors access to the returns of various market benchmarks (e.g., S&P 500, DJIA, etc.). The returns of ETNs may be linked to the performance of the associated market benchmark or strategy, generally less investor fees. Typically, when an investor buys an ETN, the issuer promises to pay the principal amount of the ETN plus the amount reflected in the associated market benchmark, minus fees, at the maturity date of the ETN. For example, an investor may purchase an ETN that is associated with the S&P 500 with a maturity date of one year. After one year, if the S&P 500 gained 10%, then the issuer would pay the investor the principal amount of the ETN, plus a return of 10% (minus fees, if applicable) on the principal amount.

Though often associated with a market benchmark, ETNs generally are not equities or index funds. For example, a mutual fund or Exchange Traded Fund (“ETF”) that similarly seeks to track the performance of the S&P 500, would typically own most, if not all, of the shares of the stocks of the companies that make up the S&P 500 index. In contrast, an ETN may not own any of the underlying securities of the benchmark. Accordingly, an ETN has an additional risk compared to an ETF or mutual fund—upon any reduction of credit ratings of the issuer, or if the issuer goes bankrupt, the value of the ETN will be adversely eroded, since payment at maturity would be less certain.

### SUMMARY

According to some implementations, a method comprises creating a debt security, wherein the debt security has a creation date and a maturity date, further wherein the debt security is associated with at least one security; issuing the debt security for a purchase price; and determining a rate of return for the debt security at the maturity date, wherein the rate of return for the debt security is inversely related to a rate of return of the associated at least one security between the creation date and the maturity date.

According to some implementations, an exchange traded note comprises at least one associated security; and a rate of return, wherein the rate of return for the exchange traded note is inversely related to a rate of return of the associated at least one security between a creation date and a maturity date.

The details of one or more implementations of the debt security are set forth in the accompanying drawings and the description below. Other features, objects, and advantages of the debt security will be apparent from the description and drawings, and from the claims.

### DESCRIPTION OF DRAWINGS

The invention is illustrated in the figures of the accompanying drawings, which are meant to be exemplary and not limiting, and in which like references are intended to refer to like or corresponding parts.

FIG. 1 is an illustration of a process for creating and redeeming a debt security;

FIG. 2 illustrates an exemplary system according to an implementation.

Like reference symbols in the various drawings indicate like elements.

### DETAILED DESCRIPTION

In one implementation, a financial instrument, such as a debt security is provided whose rate of return is inversely linked or associated with the rate of return of a security or group of securities. As used herein, the term “financial instruments” includes securities, commodities and any other financial instruments created, developed or otherwise derived from an index or fund, including without limitation, ETFs, ETNs, options (including, but not limited to, options on any index or fund), futures, and swaps. In some implementations, the debt security is an ETN.

An issuer of the ETN agrees to pay a holder of the ETN the principal amount of the ETN plus a rate of return inversely proportional to the rate of return of the associated security or securities at the maturity date of the ETN. Optionally, fees for the issuer may be deducted from the amount paid to the holder of the ETN at maturity. In some implementations, the holder of the ETN may redeem the ETN prior to the maturity date of the ETN. Redemption of the ETN prior to the maturity day may obligate the holder of the ETN to pay an early redemption fee, for example.

As a non-limiting example, an issuer may create an ETN whose rate of return inversely tracks the performance of a stock. The issuer may specify a maturity date for the ETN (i.e., when the principal and return on the ETN is paid to the holder). The maturity date may be any date after the creation date, including, but not limited to, one day, one week, one year or 30 years. Any duration of time between the creation date and the maturity date may be used.

The issuer may then issue or sell the ETN to a purchaser. The ETN may be sold directly to the purchaser, or indirectly through a broker-dealer, for example. In some implementations the ETN may be sold to a purchaser for an agreed purchase price plus a fee. The fee may be a percentage of the purchase price of the ETN. For example, if the ETN is $1000 and the fee percentage is 3%, then the fee is $30. In other implementations, the fee is a fixed fee. Any type of fee arrangement may be used.

In addition, like many types of debt securities, the ETN may be bought and sold for value between the issue date and the maturity date on the open market (e.g., on a securities exchange, on an over the counter basis or negotiated basis). For example, the initial purchaser of the ETN may sell the ETN to a later purchaser for value. The later purchaser may then sell the ETN to an additional purchaser, and so forth.

Sometime on or after the maturity date of the ETN, the ETN must be repaid by the issuer. In some implementations, the repayment amount of the ETN may be the principal amount plus or minus a return proportional to the inverse of the rate of return of the associated security or securities. As a non-limiting example, if the associated security decreased in value by 5% (e.g., a rate of return of −5%) between the creation date of the ETN and the maturity date of the ETN, and the principal amount of the ETN was $1000, then the issuer may be obligated to pay the holder of the ETN $1050 ($1000+(0.05×$1000)).

In some implementations, the holder of the ETN may receive less than the principal amount of the ETN on the maturity date if the associated security or securities increased in value between the creation date and the maturity date. As a non-limiting example, if the associated security increased in value by 110% (e.g. a rate of return of +110%) between the creation and maturity dates of the ETN, and the principal amount of the ETN was $1000, then the holder would be obligated to pay the issuer of the ETN$100(1.10×$1000). In other implementations, the holder would not have to pay any amount of money to the issuer regardless of the performance of the ETN.

In some implementations, the rate of return of the ETN at the maturity date is the inverse of the rate of return of the associated security. As a non-limiting example, if the security has a rate of return of −15% between the creation date and the maturity date then the rate of return of the ETN is 15%. In other implementations, the rate of return of the ETN at the maturity date is the inverse of the rate of return of the associated security times a multiplier. In some implementations, the multiplier may be any value greater than 1. As a non-limiting example, if the multiplier is 2, and the security declines in value by 5% between the creation date and the maturity date, then the rate of return of the ETN is 10% (2×0.05).

In some implementations, where the rate of return of the associated security is positive (e.g., increases in value between the creation date and the maturity date), the holder of the ETN may see a negative rate of return for the ETN. As a non-limiting example, the security may have a rate of return of 25%. The rate of return of the corresponding ETN may then be approximately −25% at the maturity date. If the ETN was purchased for $1000, the issuer may pay the holder of the ETN $750 ($1000−(0.25×$1000)).

In some implementations, a fee is charged by the issuer for the redemption of the ETN prior to maturity. The fee may be proportional to the amount paid for the ETN by the issuer. As a non-limiting example, if the issuer pays $1000 for the ETN and the redemption fee is 2%, then the holder may pay the issuer $20 (0.02×$1000). In other implementations, the redemption fee is proportional to the return of the ETN. As a non-limiting example, if the return of the ETN is $100 and the fee is 5% of return, then the holder must pay $5 (0.05×$100). Other fee arrangements or combination of fee arrangements may be used.

In some implementations, the rate of return of the ETN is inversely proportional to the performance of a single security. In other implementations, the rate of return of the ETN is inversely proportional to the performance of multiple securities. As a non-limiting example, the rate of return of an ETN may be inversely proportional to a group of stocks such as IBM, Disney and Microsoft. In still other implementations, the rate of return of the ETN may be inversely proportional to the rate of return of multiple ETNs, or other debt securities.

As described above, in some implementations, the ETN is associated with one or more securities and its rate of return is inversely related to the rate of return of the associated one or more securities. Thus, the ETN allows investors to approximate the financial return from short selling a particular security. As a non-limiting example, if an investor wishes to short sell a stock such as Microsoft, the investor can purchase an ETN whose rate of return is inversely proportional to the rate of return of Microsoft stock. If the shares of Microsoft decrease between the creation date of the ETN and the maturity date of the ETN (e.g., have a negative rate of return), the investor will realize a rate of return that approximates, or is equal to, the rate of return the investor would have realized had he or she sold short Microsoft at the time of the creation of the ETN.

The debt security described above offers an advantage over short selling for certain securities. As described above, Regulation SHO puts several restrictions on the ability of investors to short sell stocks or other securities. In particular, a broker-dealer must have reasonable grounds to believe that a security can be borrowed so that it can be delivered on the date delivery is due before effecting a short sale order in any security. Thus, certain stocks having a low number of shares or volume may be unavailable to an investor for short selling. Similarly, certain securities may be on the “Hard-to-Borrow” list and therefore unavailable for short selling. A purchaser who wishes to short sell one of the stocks on the “Hard-to-Borrow” list may purchase a debt security (as described herein) associated with the stock rather than short sell the stock. At the maturity date of the debt security, the purchaser will realize a rate of return that approximates, or equals, the rate of return the purchaser may have realized had the purchaser been able to short sell the associated stock.

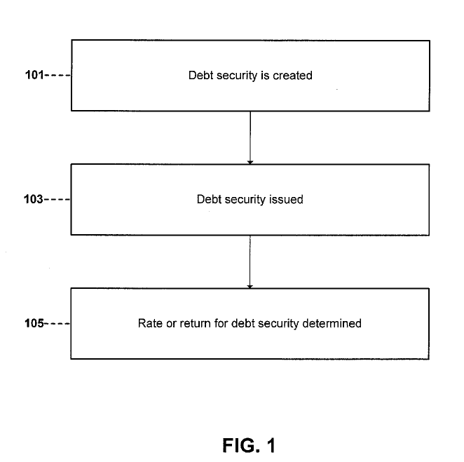

FIG. 1 is an illustration of a process (100) for creating and redeeming a debt security. A debt security is created by an investment bank or issuer (101). In some implementations, the debt security is an ETN. However, other types of debt securities may also be used.

The debt security may have a creation date and a maturity date. The creation date is the date the debt security is created or will issue and is used as the date from which the performance of one or more securities associated with the ETN will be measured. The maturity date is the date that the ETN may be repaid by the issuer, and is used as the ending date for the purposes of measuring the rate of return of the one or more securities associated with the ETN. The difference between the creation date and the maturity date may be a variety of periods of time including, but not limited to, 1 day, 1 week, 1 year, 30 years, etc.

The debt security may be associated with at least one security. The security may include stocks, bonds, or any security type known in the art. In addition, the debt security may be associated with one or more ETNs. The debt security may be associated with at least one stock that is difficult to short sell or that is on the “Hard-to-Borrow” list.

After the debt security is created (101), the debt security is issued (103). The debt security may be issued by the issuer to a purchaser. The purchaser may purchase the issued debt security directly from the issuer, or indirectly through a broker-dealer, for example. The purchase price of the debt security may be determined by the issuer or broker-dealer based on the security associated with the debt security. In some implementations, the issuer may charge the purchaser a fee. The fee may be a flat fee, or a percentage of the purchase price of the debt security, for example. Other fee arrangements may also be used.

A rate of return for the debt security at the maturity date is determined (105). The rate of return for the debt security may be inversely related to a rate of return of the associated at least one security between the creation date and the maturity date of the debt security. The rate of return for the debt security may be positive or negative. As a non-limiting example, if the debt security is associated with a stock, and the stock decreases in value 8% between the creation date and the maturity date (i.e., has a rate of return of −8%), the rate of a return for the debt security may be 8%.

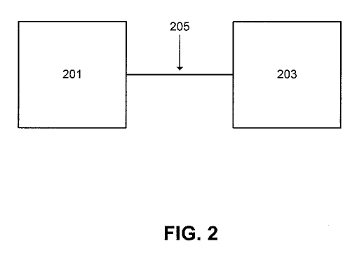

FIG. 2 illustrates an exemplary system, such as a computer system having, for example, a processor 201 (or multiple processors) running useful software, and associated memory 203 (or multiple memory devices). Processor 201 and memory 203 may, for example, be connected through a local bus 205. In an alternative embodiment, the system may be a distributed system or network, in which processor 201, memory 203, and/or other parts of the system are geographically or topographically distributed, for example over a Local Area Network, Wide Area Network, the Internet, or other network or communication link. Alternatively, memory 203 may be present as a part of processor 201. As understood in the art, software may be provided to perform one or more of the functions described above, using relevant data. Data may be input directly from an external source (such as a keyboard, touch screen, modem, etc.) or may be provided from memory 203.

Processor 201 may cooperate with memory 203, as understood in the art, to run software for performing one or more of the steps described above. As a non-limiting example, processor 201, in cooperation with memory 203, may perform one or more steps of the process 100.

Buyers or sellers may utilize a trading system. In an exemplary implementation, buyers or sellers may register to use the system in any suitable manner as known in the art. Alternatively, the system may be used for onetime use without having to register or be a subscriber. The term “subscriber” as used herein is understood to be construed broadly, for example to encompass both buyers and sellers who register or subscribe to use the system, as well as buyers and sellers who utilize the described system or method but do not otherwise register or pre-subscribe to the system.

When used for trading securities, the system and method preferably comply to any applicable rules and regulations of the Securities Exchange Commission (SEC). Exemplary embodiments described herein generally conform to a number of such rules and regulations in effect as of the date this application was filed. It is understood that modifications may be made based on changes in the rules and regulations, and such modifications are within the scope of the subject matter described herein.

Subscribers may include, for example, subscribers who are broker-dealers and subscribers who are non-broker-dealers. As used herein, broker-dealers include entities registered as broker-dealers under Section 15 of the Securities Exchange Act of 1934 and any other entities that act on the system in a capacity that is deemed to constitute market making or who otherwise act in a “sell side” capacity, even if such entities are not called or known as “market makers.” Broker-dealers may trade, for example as a principal or as an agent. Broker-dealers may also be referred to as “sell-side” subscribers. With regard to the trading method and trading system herein, based on current SEC regulations, subscribers who are broker-dealers are included in a class of non-qualified subscribers and may enter trade-interests in the form of orders into the system. Alternatively, if regulations change in the future, it is understood that subscribers who are broker-dealers may be included in a class of qualified and/or non-qualified subscribers, and broker-dealer subscribers may enter trade-interests in forms other than orders.

Non-broker-dealers include entities that are not registered as broker-dealers under Section 15 of the Securities Exchange Act of 1934 and do not act on the system in a capacity that is deemed to constitute market making. As understood in the art, a “market maker” refers to an entity that stands ready to buy and sell a particular security on a regular and continuous basis at a publicly quoted price, i.e., a price within regulated parameters.

Examples of non-broker-dealers include, without limitation, entities such as mutual funds, pension funds, hedge funds, insurance companies and corporations. Non-broker-dealers may also be referred to as buy-side subscribers. With regard to the trading method and trading system herein, and in accordance with current SEC regulations, subscribers who are non-broker-dealers are included in a class of qualified subscribers and may enter orders into the system and may receive alerts from the system of contra-side trade-interests. Again, it is understood that if the SEC regulations change in the future, non-broker-dealers may be qualified and/or non-qualified subscribers.

While the debt security has been described and illustrated in connection with preferred embodiments, many variations and modifications as will be evident to those skilled in this art may be made without departing from the spirit and scope of the disclosure, and the debt security is thus not to be limited to the precise details of methodology or construction set forth above as such variations and modifications are intended to be included within the scope of the debt security. Except to the extent necessary or inherent in the processes themselves, no particular order to steps or stages of methods or processes described in this disclosure, including the Figures, is implied. In many cases the order of process steps may be varied without changing the purpose, effect or import of the methods described.

What is claimed is:

1. A method comprising:
creating a debt security, wherein the debt security has a creation date and a maturity date, further wherein the debt security is associated with at least one security;
issuing the debt security with a principal amount; and
determining a rate of return for the debt security at the maturity date, wherein the rate of return for the debt security is inversely related to a rate of return of the associated at least one security between the creation date and the maturity date.

2. The method of claim 1, further comprising paying a holder of the debt security an amount of money equivalent to the principal amount of the debt security plus the principal amount times the rate of return of the debt security.

3. The method of claim 1, further comprising paying a holder of the debt security an amount of money equivalent to the principal amount of the debt security plus the principal amount times the rate of return of the debt security minus a fee.

4. The method of claim 3, wherein the fee is proportional to the rate of return of the debt security.

5. The method of claim 3, wherein the fee is proportional to the principal amount of the debt security.

6. The method of claim 3, wherein the fee is a fixed fee.

7. The method of claim 1, wherein the rate of return of the at least one security is negative.

8. The method of claim 1, wherein the debt security is an Exchange Traded Note.

9. The method of claim 1, wherein the difference between the creation date and the maturity date is one of 1 day, 1 week, 1 month, 1 year, and 30 years.

10. The method of claim 1, wherein the rate of return for the debt security is inversely related to the rate of return of the associated at least one security between the creation date and the maturity date times a multiplier.

11. The method of claim 10, wherein the multiplier is greater than one.

12. The method of claim 1, wherein the at least one security is a stock.

13. The method of claim 12, wherein the stock is on the Hard-to-Borrow list.

14. The method of claim 1, wherein the debt security is traded on a securities exchange.

15. An exchange traded note comprising:
at least one associated security; and
a rate of return, wherein the rate of return for the exchange traded note is inversely related to a rate of return of the associated at least one security between a creation date and a maturity date.
